(19) United States
(12) Patent Application Publication
(10) Pub. No.: US 2024/0347737 A1
(43) Pub. Date: Oct. 17, 2024

(54) ELECTROCHEMICAL CELL

(71) Applicant: DENSO CORPORATION, Kariya-city (JP)

(72) Inventors: Keita Takhashi, Kariya-city (JP); Naohiro Hayashi, Kariya-city (JP)

(21) Appl. No.: 18/753,247

(22) Filed: Jun. 25, 2024

Related U.S. Application Data
(63) Continuation of application No. PCT/JP2022/039287, filed on Oct. 21, 2022.

(30) Foreign Application Priority Data
Dec. 27, 2021 (JP) 2021-212758

(51) Int. Cl. H01M 4/86; C25B 11/032; C25B 11/061; H01M 8/12

(52) U.S. Cl. CPC H01M 4/8663; C25B 11/032; C25B 11/061; H01M 4/8621; H01M 2008/1293

(57) ABSTRACT

An electrochemical cell includes a metal support made of an Fe-based alloy, a cell portion, and a bonding layer. The cell portion includes: a solid electrolyte layer having oxygen ion conductivity; a first electrode layer disposed on one side of the solid electrolyte layer; and a second electrode layer disposed on the other side of the solid electrolyte layer. The bonding layer bonds the metal support and the first electrode layer. The bonding layer is made of an electronically conductive oxide containing at least one metal element of alloying elements of the Fe-based alloy of the metal support. The bonding layer has a gradient such that a concentration of the at least one metal element decreases from the metal support toward the first electrode layer.

### CROSS REFERENCE TO RELATED APPLICATION

The present application is a continuation application of International Patent Application No. PCT/JP2022/039287 filed on Oct. 21, 2022, which designated the U.S. and claims the benefit of priority from Japanese Patent Application No. 2021-212758 filed on Dec. 27, 2021. The entire disclosures of all of the above applications are incorporated herein by reference.

### TECHNICAL FIELD

The present disclosure relates to an electrochemical cell.

### BACKGROUND ART

An electrochemical cell includes a cell portion supported by a metal support. Examples of electrochemical cells include solid oxide fuel cells (hereinafter referred to as SOFC) and solid oxide electrochemical cells (hereinafter referred to as SOEC), which has a solid electrolyte layer with oxygen ion conductivity.

### SUMMARY

According to an aspect of the present disclosure, an electrochemical cell includes: a metal support made of Fe-based alloy; a cell portion including a solid electrolyte layer having oxygen ion conductivity, a first electrode layer disposed on one side of the solid electrolyte layer, and a second electrode layer disposed on the other side of the solid electrolyte layer; and a bonding layer bonding the metal support and the first electrode layer of the cell portion. The bonding layer is made of an electronically conductive oxide containing at least one metal element of alloying elements of the Fe-based alloy, and a concentration of the at least one metal element has a gradient to decrease from the metal support toward the first electrode layer.

### BRIEF DESCRIPTION OF DRAWINGS

The above and other objects, features and advantages of the present disclosure will become more apparent from the following detailed description made with reference to the accompanying drawings. In the drawings:

FIG. 1 is a diagram schematically showing a cross-section of an electrochemical cell according to an embodiment;

FIG. 2 is an enlarged view schematically showing an area A1 surrounded by a dotted line in FIG. 1;

FIG. 3 is a diagram schematically showing a concentration distribution of one metal element in alloying elements of Fe-based alloy of the metal support, in a thickness direction of a bonding layer;

FIG. 4 is an explanatory diagram showing examples, in which an oxide layer derived from an Fe-based alloy is present or not on a surface of a metal support, and a coating layer is present or not on a surface of a bonding layer;

FIG. 5 is an explanatory diagram of a method for measuring a thickness of a bonding layer;

FIG. 6 is a plan view of an electrochemical cell prepared in an experimental example;

FIG. 7 shows a cation concentration distribution in a depth direction from a surface of a bonding layer adjacent to the first electrode layer, measured by secondary ion mass spectrometry (SIMS) for the electrochemical cell of Sample 1 prepared in the experimental example, in which a horizontal axis represents a depth (unit: nm) from the start of detection, and a vertical axis represents Relative Intensity (Normalized by Total ion Counts);

FIG. 8 is a diagram showing measurement results of Samples 1 to 10 in experimental examples; and

FIG. 9 is a diagram showing measurement results of Samples 11 to 18 and 1C in experimental examples.

### DETAILED DESCRIPTION

Conventionally, an electrochemical cell is known, in which a cell portion is supported by a metal support. Examples of electrochemical cells include solid oxide fuel cells (hereinafter referred to as SOFC) and solid oxide electrochemical cells (hereinafter referred to as SOEC), which has a solid electrolyte layer with oxygen ion conductivity.

An SOFC includes: a porous metal support made of a sintered body of stainless steel powder; an anode supported by the metal support and having a perovskite oxide; and a mixed layer provided between the metal support and the anode. For joining the metal support and the anode, in the mixed layer, a stainless steel powder used for the metal support is mixed with a ceramic powder used for the anode, in order to suppress delamination between the metal support and the anode due to firing in a strongly chemically-reducing atmosphere.

The conventional technology has the following issues. In an electrochemical cell equipped with a solid electrolyte layer having oxygen ion conductivity, the electrode layer is usually made of ceramics. Therefore, it is difficult to ensure bonding between the metal support and the electrode layer in the electrochemical cell. In this regard, in the prior art, the metal support and the anode are bonded by a mixed layer made of a mixture of stainless steel powder used for the porous metal support and ceramic powder used for the anode.

However, in the prior art, catalytic metal such as Ni contained in the anode is poisoned by Fe element diffused from the metal support. Therefore, the catalytic performance of the catalytic metal decreases. Accordingly, due to the Fe poisoning of the catalyst metal, it is difficult to apply the above-mentioned prior art to the joining between the metal support and the electrode layer in the electrochemical cell, in which the metal support contains Fe. Therefore, there is a need for a technique that can improve the bonding properties between a metal support containing Fe and an electrode layer.

The present disclosure provides an electrochemical cell so as to improve the bonding properties between a metal support containing Fe and an electrode layer.

According to an aspect of the present disclosure, an electrochemical cell includes: a metal support made of Fe-based alloy; a cell portion including a solid electrolyte layer having oxygen ion conductivity, a first electrode layer disposed on one side of the solid electrolyte layer, and a second electrode layer disposed on the other side of the solid electrolyte layer; and a bonding layer bonding the metal support and the first electrode layer of the cell portion. The bonding layer is made of an electronically conductive oxide containing at least one metal element of alloying elements of the Fe-based alloy, and a concentration of the at least one metal element has a gradient to decrease from the metal support toward the first electrode layer.

The electrochemical cell has the above configuration. Therefore, in the electrochemical cell, it is possible to suppress rapid change in coefficient of thermal expansion in the bonding layer. Therefore, in the electrochemical cell, the bonding property can be improved between the metal support made of the Fe-based alloy and the first electrode layer of the cell portion disposed on the metal support. Further, according to the bonding layer, since the diffusion of Fe element from the Fe-based alloy of the metal support can be suppressed, the Fe poisoning of the catalyst metal in the first electrode layer can be suppressed.

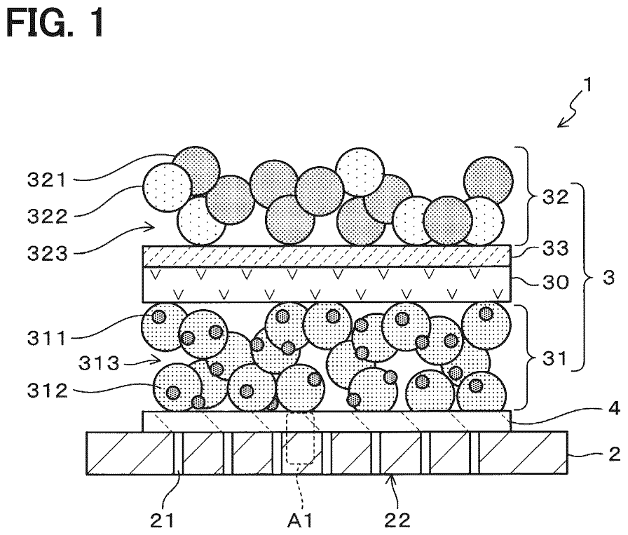

An electrochemical cell according to an embodiment will be described with reference to FIGS. 1 to 5. As illustrated in FIG. 1, the electrochemical cell 1 of the present embodiment is a metal-support electrochemical cell in which a cell portion 3 is supported by a metal support 2. The electrochemical cell 1 includes the metal support 2, the cell portion 3, and a bonding layer 4. The electrochemical cell 1 may have a flat plate shape or a cylindrical shape. In FIG. 1, the flat cell portion 3 is supported by the plate-shaped metal support 2 in the electrochemical cell 1.

The metal support 2 is made of Fe-based alloy. In the Fe-based alloy, alloying elements are added to the base Fe. The alloy elements contain at least one metal elements, and may also contain at least one non-metal element in addition to the metal element. The alloy element does not include Fe element. Further, the metal element can include a metalloid element. Examples of metal elements included in the alloy elements include Cr (chromium), Mn (manganese), Ti (titanium), Ni (nickel), Al (aluminum), Cu (copper), Mo (molybdenum), Nb (niobium), V (vanadium), La (lanthanum), Ta (tantalum), Hf (hafnium), Zr (zirconium), Si (silicon), B (boron), and the like. These can be used alone or in combination of two or more. Specifically, the metal element contained in the alloy element can include at least Cr. More specifically, at least Cr, and at least one selected from the group consisting of Mn, Ti, Ni, Al, Cu, Mo, Nb, V, La, At Ta, Hf, Zr, Si, and B can be included. In the metal support 2, the maximum added metal element having the highest content among the metal elements contained in the alloy elements of the Fe-based alloy may be one selected from the group consisting of Cr, Mn, and Ti. The Fe-based alloy containing Cr as the maximum added metal element can be referred to as a Fe—Cr-based alloy. Similarly, an Fe-based alloy containing Mn as the maximum added metal element can be referred to as a Fe—Mn-based alloy, and an Fe-based alloy containing Ti as the maximum added metal element can be referred to as a Fe—Ti-based alloy.

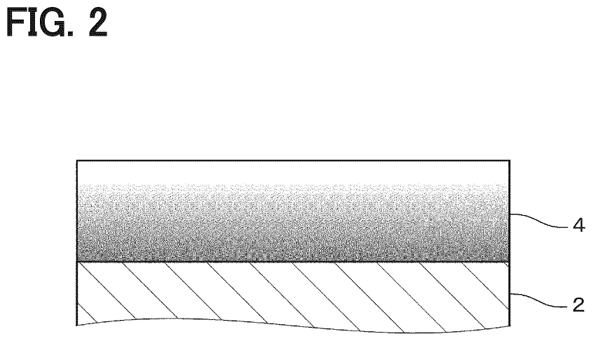

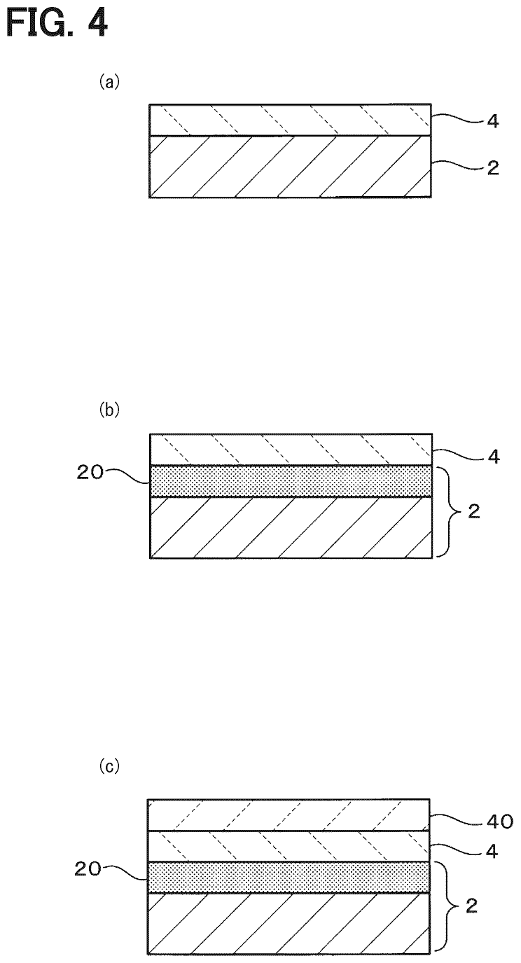

As illustrated in FIG. 1, FIG. 2 and (a) of FIG. 4, a surface of the metal support 2 may not have an oxide layer 20 derived from the Fe-based alloy. As illustrated in (b) and (c) of FIG. 4, the surface of the metal support 2 may have an oxide layer 20 derived from the Fe-based alloy. Although the oxide layer 20 can have conductivity under hydrogen, according to the former configuration, the surface of the metal support 2 and the bonding layer 4 are bonded without intervening the oxide layer 20 derived from the Fe-based alloy. Therefore, according to the former configuration, it becomes easier to reduce electrical resistance.

The metal support 2 is arranged on one side of the cell portion 3 to support the cell portion 3. The metal support 2 can be made of, for example, a solid Fe-based alloy having plural through holes 21. In FIG. 1, the metal support 2 has plural through holes 21 passing through the metal support 2 between the one side and the other side. Specifically, the metal support 2 includes a plate-shaped cell support section 22 having the plural through holes 21 passing through the plate between the one side and the other side. The through hole 21 serves as a flow path for gas supplied to the first electrode layer 31 (described later) of the cell portion 3. In FIG. 1, the through hole 21 is formed along the thickness direction of the metal support 2.

The cell portion 3 includes a solid electrolyte layer 30 having oxygen ion conductivity, a first electrode layer 31 on one side of the solid electrolyte layer 30, and a second electrode layer 32 on the other side of the solid electrolyte layer 30.

The cell portion 3 can further include an intermediate layer 33 between the solid electrolyte layer 30 and the second electrode layer 32. The intermediate layer 33 is provided mainly for suppressing the reaction between the material of the solid electrolyte layer 30 and the material of the second electrode layer 32. In this case, the cell portion 3 specifically has a structure in which the first electrode layer 31, the solid electrolyte layer 30, the intermediate layer 33, and the second electrode layer 32 are stacked in this order and joined to each other.

The solid electrolyte layer 30 has oxygen ion conductivity. Specifically, the solid electrolyte layer 30 can be formed in a layered state from a solid electrolyte having oxygen ion conductivity. The solid electrolyte layer 30 is usually formed to be dense in order to ensure gas tightness. As the solid electrolyte forming the solid electrolyte layer 30, for example, zirconium-oxide-based oxide such as yttria-stabilized zirconia (YSZ) and scandia-stabilized zirconia (ScSZ) may be preferably used from the viewpoints of excellent strength and thermal stability. As the solid electrolyte forming the solid electrolyte layer 30, for example, the yttria-stabilized zirconia may be preferably used from the viewpoints of the oxygen ion conductivity, the mechanical stability, the compatibility with other materials, and the chemical stability from an oxidizing atmosphere to a reducing atmosphere.

Examples of materials for the first electrode layer 31 include electron conductors 311 (metals and alloys, hereinafter omitted) such as Ni, Ni alloy, Cu, Cu alloy, Co, Co alloy, and oxides of the electron conductor 311 (oxides of metals and alloys, hereinafter omitted) such as Ni oxide (NiO, etc.), Cu oxide, Co oxide, which become the electron conductor 311 by reduction. These materials can be used alone or in combination of two or more. Among these, Ni, Ni alloy, Ni oxide (NiO, etc.) are preferable, and Ni is more preferable. The electron conductor 311 functions as a catalyst for an electrochemical reaction in the first electrode layer 31. The first electrode layer 31 can also contain one or more oxygen ion conductors 312 such as yttria-stabilized zirconia (YSZ) and scandia-stabilized zirconia (ScSZ). Among these, yttria-stabilized zirconia is preferred. The first electrode layer 31 may also include one or more elements selected from an oxide including at least one element selected from the group consisting of Ce, Al, La, Pr, Nd, Y, and Sc and Zr, preferably, at least one element selected from the group consisting of Al, La, Pr, Nd, Y, and Ce and Zr, or/and oxide-based additive (not shown) such as ceria (CeO₂) or ceria-based solid solution doped with at least one or more elements selected from the group consisting of Gd, Sm, Y, La, Nd, Yb, Ca, and Ho to ceria. Among these, oxide containing Ce and Zr is preferred. Examples of the oxide containing Ce and Zr include Ce—Zr—O based oxide, Ce—Zr—La—O based oxide, Ce—Zr—Sc—O based oxide, Ce—Zr—Y—O based oxide and Ce—Zr—Al—O based oxide. The metals, the alloys and the oxides described above can be combined optionally. More specifically, the first electrode layer 31 has, for example, a structure containing Ni and yttria-stabilized zirconia, a structure containing Ni, yttria-stabilized zirconia, and an oxide containing Ce and Zr, a structure containing Ni, yttria-stabilized zirconia, and ceria, or a structure containing Ni, yttria-stabilized zirconia, and a ceria-based solid solution. In the first electrode layer 31, the above-mentioned metals, alloys, and oxides can exist in the form of particles. Further, the first electrode layer 31 may be formed porous including pores 313.

The first electrode layer 31 may be composed of a single layer as illustrated in FIG. 1, or may be composed of multiple layers such as a two-layer structure. When the first electrode layer 31 is composed of multiple layers, the first electrode layer 31 specifically includes, for example, a diffusion layer disposed adjacent to the metal support 2 and a reaction layer disposed adjacent to the solid electrolyte layer 30. The diffusion layer promotes diffusion of gas introduced into the first electrode layer 31, and the reaction layer includes a reaction field where an electrochemical reaction occurs in the first electrode layer 31.

Examples of the material of the second electrode layer 32 include transition metal perovskite-type oxides 321 such as lanthanum-strontium-cobalt oxide, lanthanum-strontium-cobalt-iron oxide, and lanthanum-strontium-manganese-iron oxide. Alternatively, the second electrode layer 32 may be a mixture of the transition metal perovskite-type oxides 321 and ceria (CeO₂) or ceria-based solid solutions 322 doped with one or more elements selected from the group consisting of Gd, Sm, Y, La, Nd, Yb, Ca, and Ho to ceria. These materials can be used alone or in combination of two or more. In the second electrode layer 32, the above-mentioned transition metal perovskite-type oxide 321 and the ceria-based solid solution 322 can exist as particles. Further, the second electrode layer 32 may be formed porous including pores 323.

When the cell portion 3 includes the intermediate layer 33, the intermediate layer 33 can be specifically configured to be layered from a solid electrolyte having oxygen ion conductivity. Examples of the solid electrolyte used for the intermediate layer 33 include ceria (CeO₂) and ceria-based solid solution in which one or more elements selected from the group consisting of Gd, Sm, Y, La, Nd, Yb, Ca, and Ho are doped to ceria. These materials can be used alone or in combination of two or more. As the solid electrolyte used for the intermediate layer 33, ceria doped with Gd or the like is suitable.

The thickness of the cell portion 3 is preferably 400 μm or less, more preferably 300 μm or less, and still more preferably 150 μm or less. The thickness of the cell portion 3 is preferably 20 μm or more, more preferably 50 μm or more, and still more preferably 100 μm or more, for example, from the viewpoints of ensuring strength and improving startability.

The thickness of the solid electrolyte layer 30 can be preferably 3 to 20 μm, more preferably 3.5 to 15 μm, and still more preferably 4 to 10 μm, from the viewpoints of reducing ohmic resistance, suppressing gas permeation, and restricting a decrease in electromotive force due to electron leakage. The thickness of the first electrode layer 31 can be preferably 5 μm or more, more preferably 10 μm or more, and still more preferably 20 μm or more, for example, from the viewpoints of securing an electrochemical reaction point. The thickness of the first electrode layer 31 can be preferably 100 μm or less, more preferably 80 μm or less, and still more preferably 50 μm or less, for example, from the viewpoints of reducing ohmic resistance, and reducing gas diffusion resistance. The thickness of the second electrode layer 32 can be preferably 5 to 100 μm, more preferably 20 to 80 μm, and still more preferably 30 to 50 μm, for example, from the viewpoints of reducing ohmic resistance, reducing gas diffusion resistance, and securing an electrochemical reaction point. The thickness of the intermediate layer 33 can be preferably 1 to 20 μm, and more preferably 2 to 10 μm, for example, from the viewpoints of reducing ohmic resistance, suppressing element diffusion from the second electrode layer 32, and suppressing gas permeation. Each thickness of the cell portion 3, the solid electrolyte layer 30, the first electrode layer 31, the second electrode layer 32, and the intermediate layer 33 is an arithmetic mean value of the thickness measurements at 10 locations by scanning the cross-section along the thickness direction of the cell portion 3 using a scanning electron microscope (SEM).

The bonding layer 4 bonds the metal support 2 and the first electrode layer 31 of the cell portion 3. The bonding layer 4 is made of an electronically conductive oxide. The electronically conductive oxide contains at least one metal element of the alloying elements of the Fe-based alloy constituting the metal support 2. That is, the electronically conductive oxide contains at least one metal element derived from the alloying element of the Fe-based alloy constituting the metal support 2. Specifically, the metal element derived from the Fe-based alloy contained in the electronically conductive oxide is one diffused from the Fe-based alloy constituting the metal support. The metal element derived from the Fe-based alloy is incorporated into the structure of the electronically conductive oxide to form an electronically conductive oxide. The type of electronically conductive oxide in the bonding layer 4 can be determined from the crystal structure obtained by thin film XRD analysis.

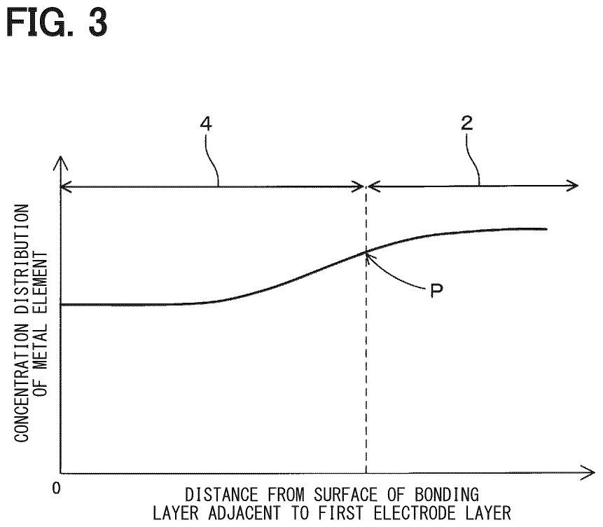

As illustrated in FIG. 3, in the bonding layer 4, the concentration of at least one metal element among the alloying elements of the Fe-based alloy constituting the metal support 2 changes to decrease from the metal support 2 toward the first electrode layer 31. In other words, in the electronically conductive oxide constituting the bonding layer 4, the concentration of at least one metal element derived from the alloying element of the Fe-based alloy is sloped to decrease from the metal support 2 to the first electrode layer 31. In order to simplify the drawing, FIG. 3 shows a state in which one metal element derived from the alloying elements of the Fe-based alloy is diffused in a sloped manner. The concentration of the metal element derived from the alloying elements of the Fe-based alloy may be gradually (slowly) reduced from the metal support 2 toward the first electrode layer 31, or may be gradually (for example, in a stepwise manner) reduced.

The gradient in concentration of the metal element in the bonding layer 4 can be measured by secondary ion mass spectrometry (SIMS). Specifically, sputtering is started from the surface of the bonding layer 4 adjacent to the first electrode layer 31, and the cation concentration distribution in the depth direction from the surface of the bonding layer 4 adjacent to the first electrode layer 31 is determined. Sputtering can be performed until the sputtering depth reaches the surface layer portion of the metal support 2 adjacent to the bonding layer 4. In the cation concentration distribution, the horizontal axis represents the depth from the start of detection (unit: nm), and the vertical axis represents Relative Intensity (Normalized by Total ion Counts). The vertical axis in the cation concentration distribution is an intensity, where the number of detections (counts) is taken as the intensity, and the total value of the number of detections and each cation value are expressed as a ratio as the relative intensity. In the obtained cation concentration distribution, the metal element contained in the alloying elements of the Fe-based alloy constituting the metal support 2 is specified, and the diffusion behavior of the specified metal element in the bonding layer 4 is confirmed. As a result, if the concentration of the specified metal element is sloped to decrease from the metal support to the first electrode layer 31 in terms of cation ratio, it can be determined that the electronically conductive oxide of the bonding layer 4 has a gradient composition. The cation concentration distribution can include the concentration distribution of Fe in addition to the concentration distribution of each metal element contained in the alloying elements of the Fe-based alloy constituting the metal support 2. As the secondary ion mass spectrometer, for example, a time-of-flight secondary ion mass spectrometer “TOF. SIMS5” manufactured by ION-TOF can be used. Furthermore, 209Bi₁_{⁺} is used as the irradiation ion.

Specific examples of the metal element derived from the Fe-based alloy contained in the electronically conductive oxide constituting the bonding layer 4 include Cr, Mn, and Ti. These can be used alone or in combination of two or more.

The bonding layer 4 can be configured such that the concentration of at least the maximum added metal element having the highest content among the metal elements contained in the alloying elements of the Fe-based alloy constituting the metal support 2 is sloped. The content of the metal element in the Fe-based alloy is expressed in mass %. According to this configuration, the bonding force of the bonding layer 4 can be strengthened. Therefore, this configuration is advantageous in improving the bonding property between the metal support and the first electrode layer.

Specifically, the maximum added metal element can be one selected from the group consisting of Cr, Mn, and Ti. The Cr, Mn, and Ti are elements that can form the electronically conductive oxide. Therefore, according to this configuration, the maximum added metal element diffused from the metal support 2 is easily incorporated into the structure of the electronically conductive oxide of the bonding layer 4. The maximum added metal element is preferably Cr. In this case, the Fe-based alloy of the metal support 2 is a Fe—Cr alloy. The Fe—Cr alloy is suitable as a material for the metal support 2 in the electrochemical cell 1 due to the excellent balance among corrosion resistance, structural strength, cost, and the like.

Regarding at least one metal element among the alloying elements of the Fe-based alloy, each slope distance is determined, which is a distance of the region where the concentration of the metal element is sloped in the layer thickness direction. When the maximum slope distance, which is the maximum among the slope distances, is defined, the bonding layer 4 can be configured such that the maximum slope distance is 0.1 μm or more. According to this configuration, by increasing the slope distance, it is possible to more reliably suppress a sudden change in coefficient of thermal expansion in the bonding layer 4, and the bonding performance of the bonding layer 4 can be improved.

Specifically, the slope distance can be determined by measuring a distance between a slope starting point and a surface position of the bonding layer 4 adjacent to the first electrode layer 31. The slope starting point is an inflection point position (the reference numeral P in FIG. 3) where the concentration of the metal element changes to attenuation for the first time, when the metal support 2 is a reference, in the concentration distribution of the metal element in the bonding layer 4. The surface position of the bonding layer 4 adjacent to the first electrode layer 31 is also the starting point of sputtering according to the SIMS analysis. The maximum slope distance can be preferably 0.15 μm or more, more preferably 0.2 μm or more, and even more preferably 0.5 μm or more, from the viewpoint of improving the bonding properties of the bonding layer 4. The longer the maximum slope distance is with respect to the thickness of the bonding layer 4, the better. The upper limit is not particularly limited, but may be, for example, equal to or less than the thickness of the bonding layer 4. From the viewpoint of bonding strength of the bonding layer 4, preferably, the maximum added metal element has the maximum slope distance.

The thickness of the bonding layer 4 can be 0.2 μm or more. According to this configuration, it is possible to sufficiently secure a region where the concentration of the metal element in the electronically conductive oxide of the bonding layer 4, which is derived from the Fe-based alloy, can be sloped. Therefore, according to this configuration, the bonding force of the bonding layer 4 can be ensured more stably. From the viewpoint of ensuring stable bonding force of the bonding layer 4, the thickness of the bonding layer 4 is preferably 0.2 μm or more, more preferably 1 μm or more, and still more preferably 5 μm or more. Further, from the viewpoint of reducing resistance, the thickness of the bonding layer 4 is preferably 20 μm or less, more preferably 15 μm or less, and still more preferably 10 μm or less.

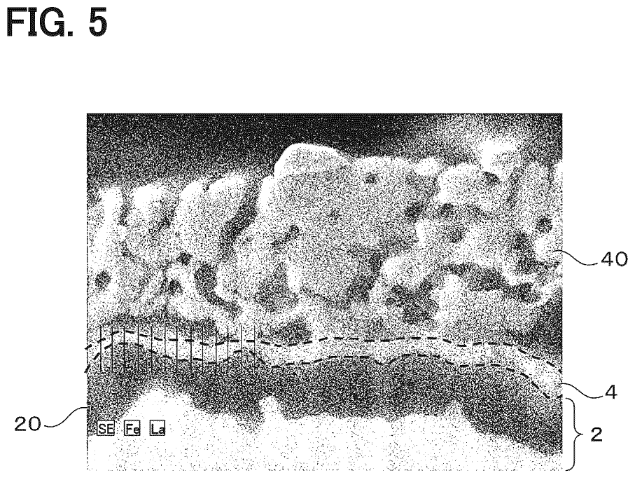

The thickness of the bonding layer 4 can be measured as follows. SEM-EDX (scanning electron microscope-energy dispersive X-ray spectroscopy) is performed on a cross-section along the thickness direction of the electrochemical cell 1. An elemental mapping image is obtained, as shown in FIG. 5, which contains elements derived from the bonding layer 4. The bonding layer 4 in the obtained elemental mapping image is divided by straight lines along the thickness direction of the bonding layer 4 at arbitrary equal intervals in a direction perpendicular to the thickness direction of the bonding layer 4. The layer thickness of the bonding layer 4 in the divided portions (n number=10 or more) is measured, and the arithmetic mean value of the measured layer thicknesses is taken as the thickness of the bonding layer 4.

The electrochemical cell 1 can be configured such that the coverage rate of the metal support 2 with the bonding layer 4 is 90% or more. In the bonding layer 4 made of the electronically conductive oxide, grain growth occurs during firing, and fine holes may occur. If holes are formed, a part of the first electrode layer 31 and a part of the metal support 2 may come into contact with each other through the holes. According to the above configuration, it is possible to reduce the number of contact points between the metal support 2 and the first electrode layer 31. Thus, it becomes easier to suppress the Fe poisoning of the catalyst metal contained in the first electrode layer 31. The coverage rate is an index indicating how much the bonding layer 4 covers the surface portion of the metal support 2 corresponding to the external size of the bonding layer 4 formed on the surface of the metal support 2. In calculating the coverage rate, the area of the surface portion of the metal support 2 located outside the external shape of the bonding layer 4 is not taken into account.

The coverage rate can be preferably 92% or more, more preferably 95% or more, from the viewpoint of sufficiently obtaining the above effects. The higher the coverage rate, the better, but from the viewpoint of manufacturability, the coverage rate can be set to, for example, 98% or less.

The coverage rate of the metal support 2 by the bonding layer 4 can be measured as follows. When the bonding layer 4 is exposed to the outside, such as when the outer shape of the bonding layer 4 is formed larger than the outer shape of the first electrode layer 31, SEM-EDX is performed to the surface of the bonding layer 4 in the exposed portion so as to obtain an elemental mapping image of elements originating from the bonding layer 4. The ratio (%) of entire area of the bonding layer 4 occupied in the entire image area (the sum area of the total area of the bonding layer 4 and the total area of the holes) can be calculated by the image analysis of the obtained elemental mapping image, relative to the viewing angle where only the bonding layer 4 exists. When the bonding layer 4 is not exposed to the outside, such as when the outer shape of the bonding layer 4 and the outer shape of the first electrode layer 31 are formed to be the same, FIB (focused ion beam)-SEM-EDX is used. The electrode portion is removed from the first electrode layer 31 by FIB, and the image analysis is performed in the same manner as above for the viewing angle where only the bonding layer 4 is present when the bonding layer 4 is exposed. Accordingly, the ratio (%) of the total area of the bonding layer 4 to the area of the entire image (the sum area of the total area of the bonding layer 4 and the total area of the holes) can be calculated.

The electronically conductive oxide of the bonding layer 4 contains at least one metal element of the alloying elements of the Fe-based alloy constituting the metal support 2, as described above. The electronically conductive oxide of the bonding layer 4 can further contain La element. In this case, the electronically conductive oxide may be a composite oxide containing La and at least one metal element of the alloying elements of the Fe-based alloy constituting the metal support 2. According to the above configuration, when Cr diffuses from the metal support 2 to the bonding layer 4, a composite oxide containing La and Cr is formed, so that the resistance of the bonding layer 4 can be easily lowered. The electronically conductive oxide has a perovskite structure, a structure similar to a perovskite structure (a structure whose composition has a gradient and is not a complete perovskite structure), or a structure similar to a perovskite structure. In this case, the La element will be included in the A site.

As illustrated in (c) of FIG. 4, and FIG. 5, the bonding layer 4 can have a coating layer 40 that covers the surface of the bonding layer 4 adjacent to the first electrode layer 31. That is, in this case, the coating layer 40 is interposed between the bonding layer 4 and the first electrode layer 31. The coating layer 40 may have a lower Fe concentration than the bonding layer 4. According to the above configuration, the coating layer 40 functions as a barrier film and can further suppress the diffusion of Fe element, which is a poisonous substance derived from the Fe-based alloy constituting the metal support 2, into the first electrode layer 31.

The thickness of the coating layer 40 can be 1.5 μm or more. According to this configuration, it becomes possible to further suppress diffusion of Fe element, which is a poisonous substance derived from the Fe-based alloy constituting the metal support 2, into the first electrode layer 31. The thickness of the coating layer 40 can be preferably 1.5 μm or more, more preferably 2.5 μm or more, and even more preferably 5 μm or more, from the viewpoint of suppressing the diffusion of Fe element, which is a poisonous substance. Further, from the viewpoint of reducing resistance, the thickness of the coating layer 40 is preferably 50 μm or less, more preferably 20 μm or less, and even more preferably 10 μm or less.

The thickness of the coating layer 40 can be measured as follows. SEM-EDX is performed on a cross-section along the thickness direction of the electrochemical cell 1 to obtain an elemental mapping image containing elements originating from the coating layer 40. The coating layer 40 in the obtained elemental mapping image is divided by straight lines along the thickness direction of the coating layer 40 at arbitrary equal intervals in a direction perpendicular to the thickness direction of the coating layer 40. The layer thicknesses of the coating layer 40 in the divided portions are measured (n number=10 or more), and the arithmetic mean value of the measured layer thicknesses is taken as the thickness of the coating layer 40.

The coating layer 40 can be made of a ceria-based oxide containing at least the element Ce. According to this configuration, the diffusivity of Fe element can be lowered. Therefore, according to this configuration, it is possible to reduce the resistance while suppressing Fe poisoning of the catalyst metal such as Ni that may be included in the first electrode layer 31. The ceria-based oxide can contain, for example, Gd, La, Mn, Cr, etc. in addition to Ce. These elements may be contained alone or in combination of two or more.

The electrochemical cell 1 can be produced, for example, as follows, but is not limited thereto.

A precursor of a bonding layer precursor is arranged on one surface of the metal support 2 made of the Fe-based alloy. The bonding layer precursor is a substance before the electronically conductive oxide is generated to form the bonding layer 4. Specifically, the bonding layer precursor is a metal oxide containing a metal element capable of forming an electronically conductive oxide, which is different from the metal element diffused from the Fe-based alloy constituting the metal support 2. Further, the precursor of the bonding layer precursor is a substance before the bonding layer precursor is generated. Specifically, the precursor of the bonding layer precursor is a substance such as a metal complex that can form the metal oxide by firing.

Next, an unfired material for forming the first electrode layer is arranged on the precursor of the bonding layer precursor to be the first electrode layer 31 by firing. Next, an unfired material for forming the solid electrolyte layer is arranged on the material for the first electrode layer, to be the solid electrolyte layer 30 by firing. Next, on the material for forming the solid electrolyte layer, if necessary, an unfired material for forming the intermediate layer is arranged to be the intermediate layer by firing. Note that, if necessary, the laminate formed on the metal support 2 is pressed using a warm isostatic press or the like. Next, the laminate formed on the metal support 2 is integrally fired together with the metal support 2. Thereby, the metal support 2 and the first electrode layer 31 are bonded via the bonding layer 4. At the time of the firing, the precursor of the bonding layer precursor is fired to form the bonding layer precursor. Further, in the bonding layer precursor, the metal element such as Cr that can form an electronically conductive oxide diffuses from the Fe-based alloy constituting the metal support 2. Thereby, a bonding layer consisting of an electronically conductive oxide is formed to have a gradient composition such that the concentration of at least one metal element of the alloying elements of the Fe-based alloy decreases from the metal support 2 to the first electrode layer 31. According to the method for manufacturing the electrochemical cell 1, the metal support 2 and the first electrode layer 31 made of ceramic can be bonded without using the metal support material itself in the bonding layer 4.

If the laminate is formed by initially arranging an electronically conductive composite oxide, which contains a metal element in the Fe-based alloy constituting the metal support 2 and another metal element different from the metal element, on one surface of the metal support 2, the crystal structure of the composite metal oxide has already been completed. In this case, it is difficult to diffuse the metal element such as Cr which can form the electronically conductive oxide from the Fe-based alloy constituting the metal support 2. Therefore, in this case, it is difficult to obtain the bonding layer 4 made of an electronically conductive oxide having a gradient composition as described above, and delamination is likely to occur.

Next, unfired material to be the second electrode layer 32 by firing is disposed on the surface of the solid electrolyte layer 30 when the intermediate layer 33 is not formed, or on the surface of the intermediate layer 33 when the intermediate layer 33 is formed. Then, this is fired, such that the second electrode layer 32 is formed. Next, the first electrode layer 31 is subjected to a reduction treatment. Thereby, the electrochemical cell 1 can be obtained.

According to the electrochemical cell 1, it is possible to suppress rapid changes in coefficient of thermal expansion in the bonding layer 4. Therefore, the electrochemical cell 1 can improve the bonding property between the metal support 2 made of the Fe-based alloy and the first electrode layer 31 of the cell portion disposed adjacent to the metal support 2. Further, according to the bonding layer 4, diffusion of Fe element from the Fe-based alloy constituting the metal support 2 can be suppressed, so that Fe poisoning of the catalyst metal such as Ni in the first electrode layer 31 can be suppressed.

The electrochemical cell 1 can be used as at least one of a solid oxide fuel cell (SOFC) and a solid oxide electrolysis cell (SOEC). That is, the electrochemical cell 1 may be operated as an SOFC, may be operated as an SOEC, and may be configured to be switchable between an SOFC mode operated as an SOFC and an SOEC mode operated as an SOEC.

In this embodiment, the first electrode layer 31 can be an electrode to which fuel gas is supplied. Specifically, when the electrochemical cell 1 is operated as an SOFC, the first electrode layer 31 can be used as a fuel electrode. A hydrogen containing gas such as hydrogen gas can be supplied to the first electrode layer 31 as a fuel gas. In this case, the second electrode layer 32 can be used as an air electrode (oxidizer electrode). The second electrode layer 32 can be supplied with an oxygen containing gas such as air or oxygen gas as the oxidant gas. On the other hand, when the electrochemical cell 1 is operated as an SOEC, the first electrode layer 31 can be used as a hydrogen electrode. A water (H₂O) containing gas such as water vapor gas can be supplied to the first electrode layer 31 as a fuel gas. In this case, the second electrode layer 32 can be used as an oxygen electrode. The second electrode layer 32 may be supplied with gas such as air, or may not be supplied with any gas. The hydrogen containing gas can contain water vapor for humidification and the like, and the water containing gas can contain a reducing gas such as hydrogen gas.

Although the present embodiment mainly describes the case where the fuel gas is supplied to the first electrode layer 31, the electrochemical cell 1 may be configured so that the fuel gas is supplied to the second electrode layer 32. In this case, the material for the second electrode layer 32 can be used as the material for the first electrode layer 31, and the material for the first electrode layer 31 can be used as the material for the second electrode layer 32. Further, in this case, the above-mentioned oxidant gas can be supplied to the first electrode layer 31. Further, in this case, the intermediate layer may be formed between the first electrode layer 31 and the solid electrolyte layer 30.

### Experimental Example

### <Electrochemical Cell of Sample 1>

A plate-shaped metal support (plate thickness: 1 mm) made of a Fe—Cr alloy was prepared, which contains Cr by 20 mass % or more and 24 mass % or less as the maximum added metal element. Specifically, the Fe—Cr alloy contains, in mass %, Cr: 20% to 24%, C: 0.03%, Mn: 0.30% to 0.80%, Si: 0.50%, Al: 0.50%, S: 0.020%, P: 0.050%, Ti: 0.03% to 0.20%, La: 0.04% to 0.20%, and the remaining is Fe and unavoidable impurities. In a part of the metal support 2 to which a cell is to be joined, multiple through holes are formed to penetrate between the one surface and the other surface.

Next, a solution containing a La₂O₃ precursor was prepared by mixing a La complex as a precursor of La₂O₃ (bonding layer precursor), butyl acetate as a solvent, and turpentine oil. A precursor of La₂O₃ was formed into a film by repeating the process of dip-coating the prepared solution onto one surface of the metal support and drying it multiple times.

Next, a paste for forming the first electrode layer was prepared by mixing NiO powder, yttria-stabilized zirconia (hereinafter referred to as YSZ) powder containing 8 mol % of Y₂O₃, ethyl cellulose as a binder, and terpineol as a solvent. The prepared paste for forming the first electrode layer was screen printed on the La₂O₃ precursor. Thereby, the material for forming the first electrode layer was arranged on the La₂O₃ precursor.

Next, a paste for forming a solid electrolyte layer was prepared by mixing YSZ powder, ethyl cellulose as a binder, and terpineol as a solvent. The prepared paste was applied onto the material for forming the first electrode layer. Thereby, the solid electrolyte layer forming material was arranged on the first electrode layer forming material.

Next, a paste for forming the intermediate layer was prepared by mixing Ce_{0.9}Gd_{0.1}O₂ (hereinafter referred to as GDC) powder, ethyl cellulose as a binder, and terpineol as a solvent. The prepared paste was screen printed on the solid electrolyte layer forming material. Thereby, the intermediate layer forming material was arranged on the solid electrolyte layer forming material.

Next, the laminate formed on the metal support was integrally fired at 1200° C. for 2 hours in an inert gas atmosphere. As a result, a sintered body was formed in which the bonding layer, the first electrode layer, the solid electrolyte layer, and the intermediate layer were stacked in this order on the metal support.

Next, a paste for forming the second electrode layer was prepared by mixing La_{0.6}Sr_{0.4}CoO₃ (hereinafter referred to as LSC) powder, GDC powder, ethyl cellulose as a binder, and terpineol as a solvent. The prepared paste for forming the second electrode layer was screen printed on the intermediate layer of the sintered body. Thereby, the second electrode layer forming material was arranged on the intermediate layer.

Next, the material for forming the second electrode layer was fired at 1000° C. for 2 hours in the air. Thereby, the second electrode layer was formed on the solid electrolyte layer.

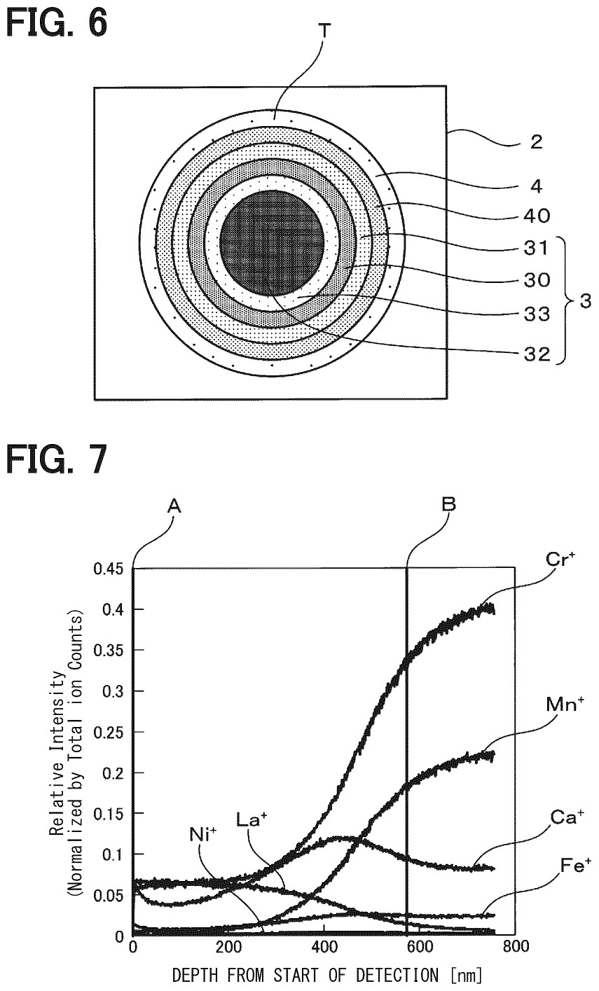

Next, the first electrode layer was subjected to a reduction treatment at 800° C. for 3 hours in a hydrogen atmosphere. Thus, an electrochemical cell of Sample 1 was obtained in which the first electrode layer is bonded to one plate surface of a metal support through a boding layer, in the cell portion where the first electrode layer (thickness: 60 μm), the solid electrolyte layer (thickness: 3 μm), the intermediate layer (thickness: 3 μm), and the second electrode layer (thickness: 10 μm) are stacked in this order. In the electrochemical cell of Sample 1, a hydrogen-containing gas such as hydrogen gas is supplied to the first electrode layer as a fuel gas. In this experimental example, as illustrated in FIG. 6, the bonding layer 4, the coating layer 40 (not formed in the electrochemical cell of Sample 1), the first electrode layer 31, the solid electrolyte layer 30, the intermediate layer 33, and the second electrode layer 32 are stacked on the one plate surface of the metal support 2, so that their respective external shapes gradually became smaller. Note that the electrochemical cell of the present disclosure is not limited to the form illustrated in FIG. 6.

### <Electrochemical Cell of Sample 2 and Sample 3>

An electrochemical cell of Sample 2 was produced in the same manner as the electrochemical cell of Sample 1, except that the firing time for forming the sintered body up to the intermediate layer was 0.5 hours.

An electrochemical cell of Sample 3 was produced in the same manner as the electrochemical cell of Sample 1, except that the firing time for forming the sintered body up to the intermediate layer was 10 hours.

### <Electrochemical Cell of Sample 4 and Sample 5>

A solution containing a ZnO precursor was prepared by mixing a Zn complex as a ZnO (bonding layer precursor) precursor, butyl acetate as a solvent, and turpentine oil. An electrochemical cell of Sample 4 was produced in the same manner as the electrochemical cell of Sample 1, except that a solution containing a ZnO precursor was used, and that a plate-shaped metal support was used, which is made of an Fe—Mn alloy containing Mn of 10 mass % to 20 mass % as the maximum added metal element.

A solution containing a TiO precursor was prepared by mixing a Ti complex as a TiO (bonding layer precursor) precursor, butyl acetate as a solvent, and turpentine oil. An electrochemical cell of Sample 5 was produced in the same manner as the electrochemical cell of Sample 1, except that a solution containing a TiO precursor was used, and a plate-shaped metal support was used, which is made of an Fe—Ti alloy containing Ti, as the maximum added metal element, of 10 mass % to 20 mass %.

### <Electrochemical Cell of Sample 6 and Sample 7>

An electrochemical cell of Sample 6 was produced in the same manner as the electrochemical cell of Sample 1, except that the number of repetitions of the step of dip-coating a solution containing a La₂O₃ precursor onto one surface of the metal support and drying it was reduced, and that the oxide layer derived from the Fe-based alloy on the surface layer of the metal support was removed.

An electrochemical cell of Sample 7 was produced in the same manner as the electrochemical cell of Sample 1, except that the number of repetitions of the step of dip-coating a solution containing a La₂O₃ precursor onto one surface of the metal support and drying it was reduced (less than that in Sample 6) and that the oxide layer derived from the Fe-based alloy on the surface layer of the metal support was removed.

### <Electrochemical Cell of Sample 8>

An electrochemical cell of Sample 8 was produced in the same manner as the electrochemical cell of Sample 1, except that La₂O₃ particles were mixed and dispersed in a solution containing a La₂O₃ precursor.

### <Electrochemical Cell of Sample 9 to Sample 10>

An electrochemical cell of Sample 9 was produced in the same manner as the electrochemical cell of Sample 1, except that a binder was mixed and dissolved in a solution containing the La₂O₃ precursor.

An electrochemical cell of Sample 10 was produced in the same manner as the electrochemical cell of Sample 1, except that a binder was mixed (with an increased amount compared to Sample 9) and dissolved in a solution containing the La₂O₃ precursor.

### <Electrochemical Cell of Sample 11 and Sample 12>

A solution containing a Sr(OH)₂ precursor was prepared by mixing an Sr complex as a precursor of Sr(OH)₂ (bonding layer precursor), butyl acetate as a solvent, and turpentine oil. An electrochemical cell of Sample 11 was produced in the same manner as the electrochemical cell of Sample 1, except that the solution containing the Sr(OH)₂ precursor was used.

A solution containing a MnO₂ precursor was prepared by mixing an Mn complex as a precursor of MnO₂ (bonding layer precursor), butyl acetate as a solvent, and turpentine oil. An electrochemical cell of Sample 12 was produced in the same manner as the electrochemical cell of Sample 1, except that the solution containing the MnO₂ precursor was used.

### <Electrochemical Cell of Sample 13>

A paste for forming a coating layer was prepared by mixing Ce_{0.9}Gd_{0.1}O₂ (GDC) powder, ethyl cellulose as a binder, and terpineol as a solvent. An electrochemical cell of Sample 13 was produced in the same manner as the electrochemical cell of Sample 1, except that the material for forming the first electrode layer was deposited on the material for forming the coating layer, after the paste for forming the coating layer is screen printed on the La₂O₃ precursor to form the material for forming the coating layer. In the electrochemical cell of Sample 13, the coating layer (thickness: 2 μm) is interposed between the bonding layer and the first electrode layer.

### <Electrochemical Cell of Samples 14 to 16>

An electrochemical cell of Sample 14 was produced in the same manner as the electrochemical cell of Sample 13, except that a coating layer forming paste of Ce_{0.9}Gd_{0.1}O₂ (GDC) powder was replaced with LaFeO₃ powder.

An electrochemical cell of Sample 15 was produced in the same manner as the electrochemical cell of Sample 13, except that a coating layer forming paste of Ce_{0.9}Gd_{0.1}O₂ (GDC) powder was replaced with MnO₂ powder.

An electrochemical cell of Sample 16 was produced in the same manner as the electrochemical cell of Sample 13, except that a coating layer forming paste of Ce_{0.9}Gd_{0.1}O₂ (GDC) powder was replaced with MnCr₂O₄ powder.

### <Electrochemical Cell of Samples 17 to 18>

An electrochemical cell of Sample 17 and an electrochemical cell of Sample 18 were produced by changing the film thickness of the coating layer forming paste during screen printing in producing the electrochemical cell of Sample 13. In the electrochemical cell of Sample 17, a coating layer (thickness of 1.5 μm) was provided between the bonding layer and the first electrode layer. In the electrochemical cell of Sample 18, a coating layer (thickness of 0.2 μm) was provided between the bonding layer and the first electrode layer.

### <Electrochemical Cell of Sample 1C>

A solution containing the La complex and the Cr complex was prepared by mixing the La complex, the Cr complex, butyl acetate as a solvent, and turpentine oil. An electrochemical cell of Sample 1C was produced in the same manner as the electrochemical cell of Sample 1, except that the solution containing the La complex and the Cr complex was used instead of the solution containing the La₂O₃ precursor.

### <Various Measurements>

For each electrochemical cell produced, the type of electronically conductive oxide in the bonding layer, the presence or absence of a gradient composition, the maximum slope distance, the thickness of the bonding layer, and the coverage of the metal support by the bonding layer were measured using measurement methods. Further, the electrical resistance of the bonding layer was measured by forming an electrode layer on the bonding layer and measuring the DC resistance through the metal support.

Further, for each electrochemical cell, a peel test was conducted in which the cell portion was peeled off from the metal support, and the peel strength was measured. Specifically, the evaluation was performed using a surface and interfacial cutting analysis system (SAICAS).

In addition, for each electrochemical cell, the Fe poisoning situation was investigated in the Ni portion, which is the catalyst metal of the first electrode layer. Specifically, with respect to the cross-section along the thickness direction of the first electrode layer, the Ni portion was quantified by point analysis using SEM-EDX, and the mass concentrations of Fe element and Ni element were measured. Then, the value of Fe/(Fe+Ni) (mass %/mass %) in the Ni portion of the first electrode layer was calculated as the arithmetic mean value of n=20.

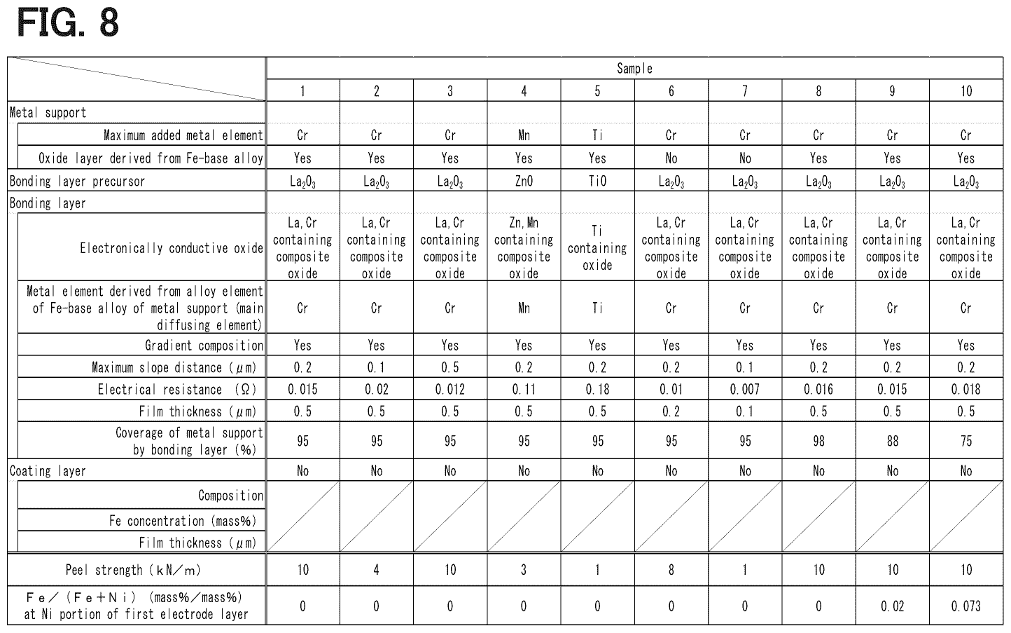

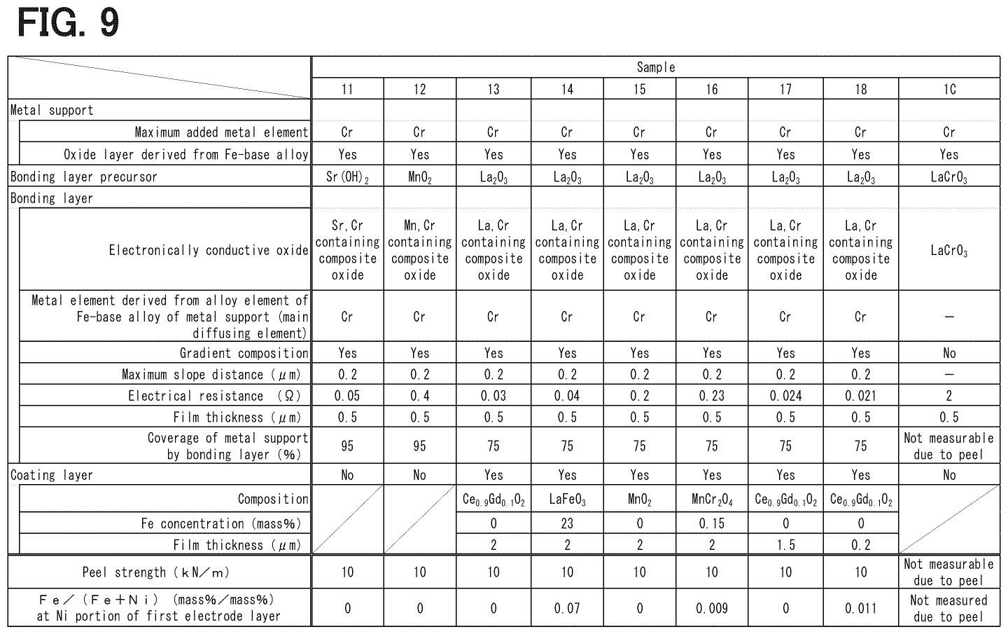

The detailed configuration of each electrochemical cell and various measurement results are summarized in FIG. 8 and FIG. 9. FIG. 7 shows the cation concentration distribution in the depth direction from the surface of the bonding layer adjacent to the first electrode layer, measured by the secondary ion mass spectrometry (SIMS) for the electrochemical cell of Sample 1 prepared in Experimental Example 1. The position A in FIG. 7 represents the surface of the bonding layer adjacent to the first electrode layer. In this example, since the measurement is performed at point T in FIG. 6, that is, at a location where the bonding layer is exposed, the bonding layer is detected from the start of detection. Further, the position B in FIG. 7 represents the interface between the bonding layer and the metal support, where the concentration of the main diffusing element (Cr in this example) reaches an inflection point.

According to FIG. 7, FIG. 8 and FIG. 9, the following can be confirmed. In the electrochemical cell of Sample 1C, it was not possible to improve the bonding property between the metal support and the first electrode layer, as the metal support and the first electrode layer of the cell portion are peeled off. In the electrochemical cell of Sample 1C, LaCrO₃ completed as a perovskite structure was used as the material for forming the bonding layer. The metal element capable of forming an oxide could not be diffused from the metal support into the bonding layer, and a rapid change in coefficient of thermal expansion in the bonding layer could not be suppressed.

In contrast, in the electrochemical cells of Samples 1 to 18, no peeling occurs between the metal support and the first electrode layer of the cell portion, and the bonding property between the metal support and the first electrode layer is improved. This is because the metal element that can form the electronically conductive oxide, such as Cr, derived from the Fe-based alloy constituting the metal support, is diffused from the metal support into the precursor of the electronically conductive oxide during firing. Thus, the bonding layer made of the electronically conductive oxide was formed, and a sudden change in coefficient of thermal expansion in the bonding layer could be suppressed. In addition, the electrochemical cells of Samples 1 to 18 can suppress the diffusion of Fe element from the Fe-based alloy constituting the metal support by having a specific bonding layer, and can suppress the Fe poisoning of Ni, which is a catalyst metal in the first electrode layer.

Furthermore, according to the electrochemical cells of Samples 1 to 3, it can be seen that the larger the value of the maximum slope distance in the bonding layer, the easier it is to increase the bonding force of the bonding layer. Then, it can be seen that it becomes easier to improve the bonding property of the bonding layer by setting the maximum slope distance to 0.1 μm or more.

Furthermore, according to the electrochemical cells of Sample 1, Sample 4, and Sample 5, when the electronically conductive oxide constituting the bonding layer contains Cr as a metal element capable of forming an electronically conductive oxide, it can be seen that the bonding strength of the bonding layer can be increased more easily than in the case of containing Mn or Ti. This is because the gradient was formed by the maximum added metal element in the Fe-based alloy constituting the metal support.

Further, according to the electrochemical cells of Sample 1, Sample 6, and Sample 7, it can be seen that the larger the thickness of the bonding layer, the easier it is to increase the bonding force of the bonding layer. Then, it can be seen that the bonding force of the bonding layer can be more stably ensured by setting the thickness of the bonding layer 4 to 0.2 μm or more.

Furthermore, according to the electrochemical cells of Samples 1 and 8 to 10, the Fe poisoning of the catalyst metal contained in the first electrode layer can be further reduced by making the coverage of the metal support by the bonding layer as 90% or more. This is because the number of contacts between the metal support and the first electrode layer is reduced by reducing the number of holes in the bonding layer.

Furthermore, according to the electrochemical cells of Sample 1, Sample 11, and Sample 12, it can be seen that it is easier to lower the resistance of the bonding layer when the electronically conductive oxide constituting the bonding layer is a composite oxide that contains metal elements such as La and Cr that can form the electronically conductive oxide, compared with a composite oxide containing a metal element such as Sr and Cr capable of forming an electronically conductive oxide, or a composite oxide containing a metal element such as Mn and Cr capable of forming an electronically conductive oxide.

Furthermore, according to the electrochemical cells of Sample 1 and Samples 13 to 16, even in case where the coverage of the metal support by the bonding layer is relatively low, when the bonding layer has the coating layer, the coating layer becomes a barrier film. Thus, the diffusion of Fe element, which is a poisonous substance, into the first electrode layer can be suppressed. At this time, according to the electrochemical cells of Samples 13 and 14, and the electrochemical cells of Samples 15 and 16, it can be seen that it becomes easier to suppress the diffusion of the Fe element, which is a poisonous substance, to the first electrode layer, by lowering the Fe concentration in the coating layer.

Further, according to the electrochemical cells of Samples 13, 17, and 18, it can be seen that the diffusion of Fe element, which is a poisoning substance, into the first electrode layer can be easily suppressed by setting the thickness of the coating layer to 1.5 μm or more.

The present disclosure is not limited to each of the embodiments and experimental examples, and various modifications can be made without departing from the gist of the present disclosure. In addition, each configuration shown in each embodiment and each experimental example can be optionally combined. That is, although the present disclosure has been described in accordance with the embodiments, it is understood that the present disclosure is not limited to the embodiments, structures, and the like. The present disclosure encompasses various modifications and variations within the scope of equivalents. In addition, while the various elements are shown in various combinations and configurations, which are exemplary, other combinations and configurations, including more, less or only a single element, are also within the spirit and scope of the present disclosure.

What is claimed is:

1. An electrochemical cell comprising:
a metal support made of Fe-based alloy;
a cell portion including a solid electrolyte layer having oxygen ion conductivity, a first electrode layer disposed on one side of the solid electrolyte layer, and a second electrode layer disposed on the other side of the solid electrolyte layer; and
a bonding layer bonding the metal support and the first electrode layer of the cell portion, wherein
the bonding layer is made of an electronically conductive oxide containing at least one metal element of alloying elements of the Fe-based alloy,
a concentration of the at least one metal element has a gradient to decrease from the metal support toward the first electrode layer, and
the electronically conductive oxide constituting the bonding layer contains La element.

2. The electrochemical cell according to claim 1, wherein
the bonding layer has a coating layer that covers a surface of the bonding layer adjacent to the first electrode layer, and
the coating layer has a lower Fe concentration than the bonding layer.

3. The electrochemical cell according to claim 2, wherein the coating layer is made of a ceria-based oxide containing at least Ce element.

4. The electrochemical cell according to claim 2, wherein a thickness of the coating layer is 1.5 μm or more.

5. An electrochemical cell comprising:
a metal support made of Fe-based alloy;
a cell portion including a solid electrolyte layer having oxygen ion conductivity, a first electrode layer disposed on one side of the solid electrolyte layer, and a second electrode layer disposed on the other side of the solid electrolyte layer; and
a bonding layer bonding the metal support and the first electrode layer of the cell portion, wherein
the bonding layer is made of an electronically conductive oxide containing at least one metal element of alloying elements of the Fe-based alloy,
a concentration of the at least one metal element has a gradient to decrease from the metal support toward the first electrode layer,
the bonding layer has a coating layer that covers a surface of the bonding layer adjacent to the first electrode layer, and
the coating layer has a lower Fe concentration than the bonding layer.

6. The electrochemical cell according to claim 5, wherein the electronically conductive oxide constituting the bonding layer contains La element.

7. The electrochemical cell according to claim 5, wherein the coating layer is made of a ceria-based oxide containing at least Ce element.

8. The electrochemical cell according to claim 5, wherein a thickness of the coating layer is 1.5 μm or more.

9. The electrochemical cell according to claim 1, wherein a surface of the metal support does not have an oxide layer derived from the Fe-based alloy.

10. The electrochemical cell according to claim 1, wherein
the bonding layer has a maximum added metal element whose content rate is the maximum among metal elements contained in the alloying elements of the Fe-based alloy, and
a concentration of at least the maximum added metal element is sloped in the bonding layer.

11. The electrochemical cell according to claim 10, wherein the maximum added metal element is Cr.

12. The electrochemical cell according to claim 1, wherein
the bonding layer has a maximum slope distance of 0.1 μm or more, the maximum slope distance being a maximum of slope distances of the at least one metal element of the alloying elements of the Fe-based alloy, each of which is a distance of a region where the concentration of the metal element is sloped in a thickness direction.

13. The electrochemical cell according to claim 1, wherein a thickness of the bonding layer is 0.2 μm or more.

14. The electrochemical cell according to claim 1, wherein a coverage rate of the metal support by the bonding layer is 90% or more.

15. The electrochemical cell according to claim 1, wherein the electrochemical cell is used as at least one of a solid oxide electrolysis cell and a solid oxide fuel cell.
